(19) United States
(12) Patent Application Publication
(10) Pub. No.: US 2026/0184334 A1
(43) Pub. Date: Jul. 2, 2026

(54) Driver-In-The-Loop Lateral Proximity Risk Mitigation

(71) Applicant: Nissan North America, Inc., Franklin, TN (US)

(72) Inventors: Qizhan Tam, San Jose, CA (US); Sachin Hagaribommanahalli Yeriyappa, San Jose, CA (US); Christopher Ostafew, Mountain View, CA (US)

(21) Appl. No.: 19/004,914

(22) Filed: Dec. 30, 2024

(51) Int. Cl. B60W 60/00; B60W 30/095

(52) U.S. Cl. CPC B60W 60/001; B60W 30/0956; B60W 2554/801; B60W 2720/103

(57) ABSTRACT

A system and method for driver-in-the-loop lateral proximity risk mitigation for an autonomous vehicle that is following a system-determined path and is adhering to a system-determined speed profile. The method includes modifying a speed of the speed profile when a driver takes control of steering and causes the vehicle to violate a lateral constraint applied to an object along the vehicle's trajectory. The lateral constraint of an object is based on a type of hazard identified for the object, which is in turn based on a classification of the object.

### TECHNICAL FIELD

This disclosure relates generally to vehicles capable of at least Level 1 autonomous speed control, and more specifically, to systems and methods that automatically modify a vehicle's speed when a driver assumes manual steering control and causes the vehicle to violate a lateral constraint associated with an object along the vehicle's path.

### BACKGROUND

Advanced Driver Assistance Systems (ADAS) are technologies integrated into vehicles to enhance safety and driving convenience by assisting drivers with tasks like steering, braking, and monitoring the environment. ADAS encompasses features such as adaptive cruise control, automatic emergency braking (AEB), lane-keeping assistance, collision avoidance, and parking assistance. The Society of Automotive Engineers (SAE) defines six levels of vehicle automation within this context. Level 0 includes no automation, where drivers handle all tasks. Level 1 involves driver assistance, where the vehicle can assist with either steering or acceleration/braking, but not both simultaneously. Level 2 allows partial automation, with control over both steering and speed under human supervision. Level 3 introduces conditional automation, where the vehicle can perform driving tasks under specific conditions but requires human intervention upon request. Level 4 achieves high automation, managing all driving functions in predefined scenarios without human input. Finally, Level 5 represents full automation, where the vehicle independently handles all driving tasks in any environment. Levels 3-5 may be considered autonomous driving (AD).

In most vehicles equipped with ADAS or AD technologies, a driver can activate autonomous cruise control while automatic emergency braking operates in the background. These systems typically allow the driver to retain manual control over steering while the vehicle automatically adjusts speed and monitors objects directly ahead. However, these Level 1 and/or Level 2 capabilities are largely limited to highway applications or emergency scenarios due to the vehicle's constrained ability to detect and respond to objects outside of a narrow frontal field of view, e.g., laterally located objects. This limitation poses challenges for extending Level 1 and/or Level 2 ADAS functionality to more complex road environments.

### SUMMARY

While the systems and methods disclosed herein can be adapted for use at all ADAS levels, this disclosure primarily focuses on enhancing the capabilities of L1 and L2 vehicles by enabling autonomous speed control in a wider range of driving scenarios. By maintaining safety thresholds, the disclosed systems and methods ensure that emergency systems like automatic emergency braking, or the driver, can intervene effectively when necessary. For example, the disclosed systems and methods allow the vehicle to respond safely to potential hazards like pedestrians emerging from behind parked cars or vehicle doors suddenly opening.

The disclosed systems and methods can integrate with existing Proactive Risk Mitigation (PRM) systems that are traditionally used for ADAS systems with both autonomous steering and speed control.

In particular, the disclosed systems and methods support ADAS systems with autonomous steering by automatically adjusting a vehicle's speed when a driver overrides the autonomous steering control. In particular, this driver-in-the-loop functionality enables the vehicle to continue along the driver's chosen path—rather than a system-determined path—by determining and applying an appropriate speed profile for the vehicle based on lateral constraints of objects along the vehicle's path. If the vehicle's deviation from the system-determined path is large enough to violate a lateral constraint of an object, the speed profile is modified and the vehicle slows down. On the other hand, if the vehicle's deviation from the system-determined path is minor and will not violate a lateral constraint of an object, the vehicle continues to obey the original speed profile associated with the system-determined path.

The lateral constraints may be based on hazard types, which may in turn be based on classifications of the objects, for example, as determined by a PRM system. Thus, the disclosed systems and methods may utilize information indicating objects and their classifications. As used herein, terms like “information indicating a classified object” denote information that encompasses information indicating the object and information indicating the classification of the object. As used herein, terms like “classified objects” may have different meanings based on context. In a context of information processing, “classified objects” may be shorthand for information indicating classified objects. For example, a computing component may receive classified objects as an input for further processing. In a context of path navigation, “classified objects” may denote physical things that could impede a vehicle's movement along the path. For example, a vehicle may slow down when confronted with some classified objects, like speed bumps, and it may drive around other classified objects, like pedestrians. Some examples of object classifications include vehicles, pedestrians, cyclists and motorcyclists, traffic infrastructure, road obstacles, animals, road features, intersections and junctions, and environmental elements. Object classifications may be general or specific. For example, a general classification may be vehicles, whereas more specific classifications may be cars, buses, trucks, and so on.

Specifically, disclosed herein are aspects, features, elements, implementations, and embodiments of a method, a system, and a non-transitory computer-readable medium for driver-in-the-loop lateral proximity risk mitigation.

A first aspect of the disclosed implementations is a method that includes the steps of: determining that a vehicle is in a manual steering mode or a manual steering override state; receiving information indicating a classified object near the vehicle; receiving a planned path, and a corresponding speed profile, for navigating the vehicle while avoiding the classified object; determining a hazard for the classified object; determining a lateral constraint for the hazard; determining a modified path, based on the planned path, that respects the lateral constraint applied to the classified object; determining that the vehicle has deviated sufficiently from the modified path to cause a current or future violation of the lateral constraint by the vehicle; and determining a modified speed profile, based on the speed profile, that comprises a reduction in a speed of the speed profile.

A second aspect of the disclosed implementations is a system that includes one or more memories and one or more processors configured to execute instructions stored in the one or more memories to implement the steps of the method described above.

A third aspect of the disclosed implementations is a non-transitory computer-readable medium storing instructions operable to cause one or more processors to perform operations according to the steps of the method described above.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system for driver-in-the-loop lateral proximity risk mitigation.

FIG. 5 is a diagram of an example of an environment for which a planned path and an optimized path have been determined for a vehicle.

FIGS. 6A-6B are diagrams of an example of a system for driver-in-the-loop lateral proximity risk mitigation under a scenario where lateral deviations from a determined path are less than a predefined threshold deviation.

FIGS. 7A-7F are diagrams of examples of a system for lateral proximity risk mitigation executing a constant speed profile based on a minimum lateral clearance along a determined path.

FIGS. 8A-8B are diagrams of an example of a system for driver-in-the-loop lateral proximity risk mitigation under a scenario where lateral deviations from a determined path are greater than a predefined threshold deviation.

FIG. 9 is a flowchart of an example of a process for driver-in-the-loop lateral proximity risk mitigation.

### DETAILED DESCRIPTION

To describe some implementations in greater detail, reference is made to the following figures.

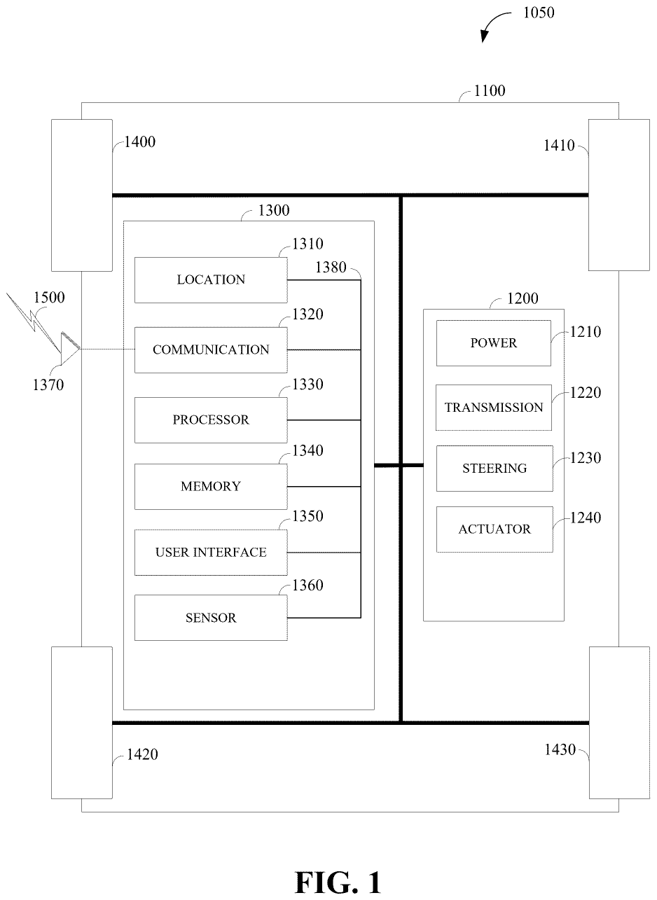

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment within or surrounding the vehicle 1050. With regard to within the vehicle 1050, e.g., the in-cabin environment, one or more sensors may detect objects within the vehicle, such as groceries, electronic devices, pets, people, in-vehicle controls, and so on. With respect to surrounding the vehicle, e.g., the external, exterior, or outside environment, one or more sensors may detect road geometry and obstacles, such as fixed obstacles, vehicles, cyclists, and pedestrians. In some embodiments, the sensor 1360 can be or include one or more still or video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

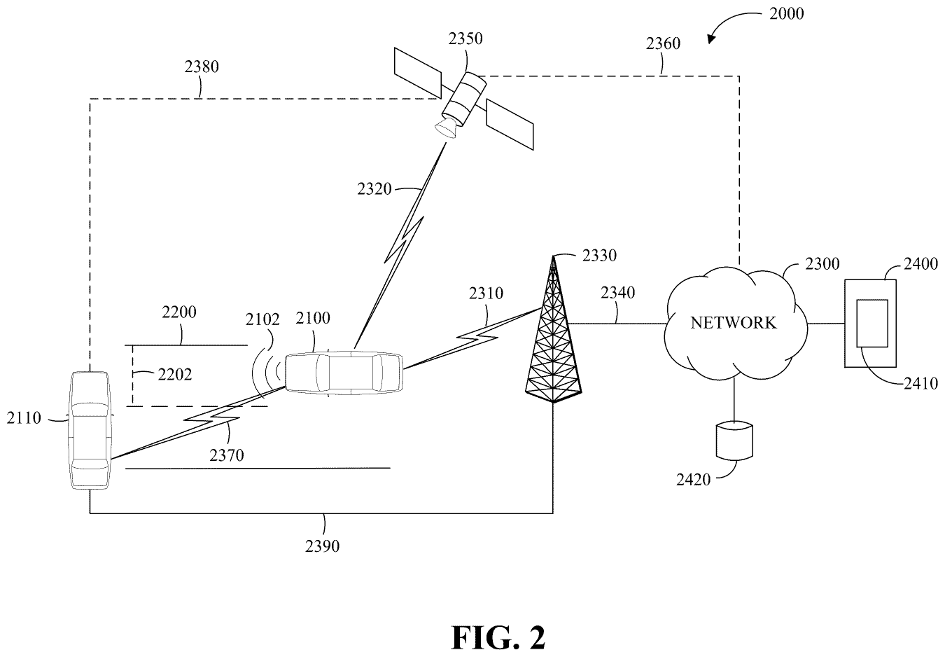

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

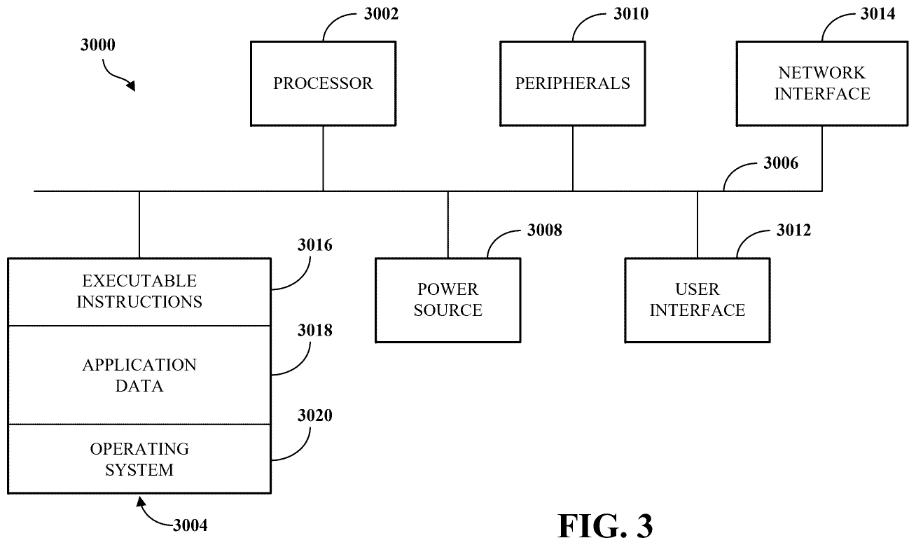

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3, which is described later herein. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 may be, for example, the controller 1300 shown in FIG. 1 or the computing apparatus 2410 shown in FIG. 2. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 shown in FIG. 2.

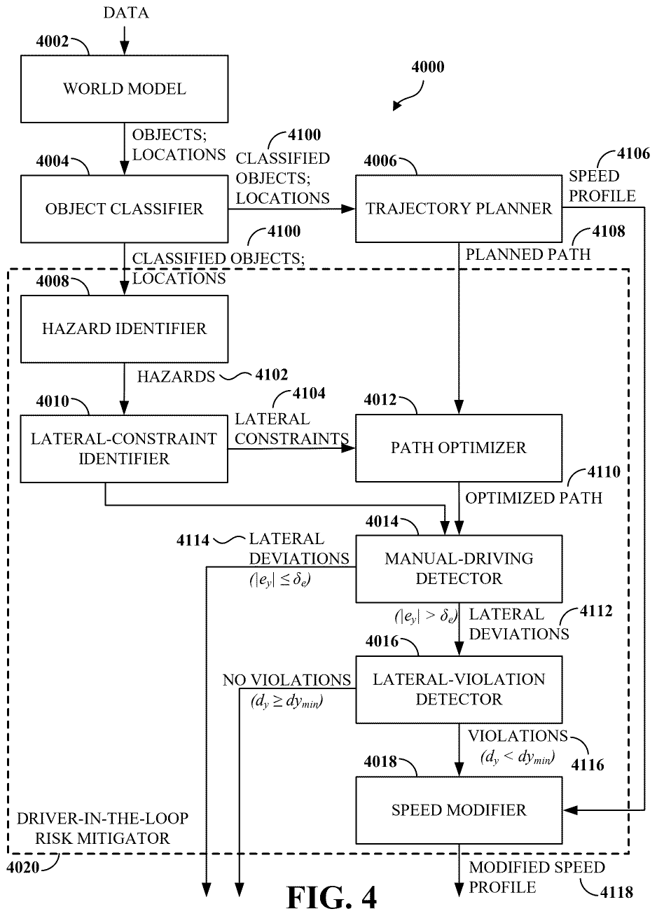

FIG. 4 is a diagram of an example of a system 4000 for driver-in-the-loop lateral proximity risk mitigation. Some or all components of the system 4000 may be implemented by one or more of the controller 1300 shown in FIG. 1 and/or the computing apparatus 2410 of the data center 2400 shown in FIG. 2. The system 4000 may be part of a PRM system of a vehicle for proactively mitigating risks for the vehicle. The system 4000 comprises a driver-in-the-loop risk mitigator 4020 that implements components for driver-in-the-loop lateral proximity risk mitigation.

The system 4000 includes a world model 4002 that receives data concerning objects in proximity to the vehicle. As used herein, the term “object” includes any object, obstruction, obstacle, or abnormality in the environment that has a potential to affect, influence, or inform the vehicle's speed and/or trajectory. The data may be sensor data acquired by sensors of the vehicle, such as the sensors 1360 shown in FIG. 1. The proximity may comprise an environment surrounding the vehicle, for example, certain distances behind, in front, to the left, and to the right of the vehicle. Such distances may be based on types and/or capabilities of sensors of the vehicle, speed of the vehicle, location of the vehicle, and so on, and are known in the art. The world model 4002 may receive raw, pre-processed, or processed sensor data that it may further process to identify physical objects in the proximity of the vehicle and to determine locations of these objects with respect to the vehicle. The world model 4002 outputs information describing the objects (and optionally their locations, poses, motions, etc.) to an object classifier 4004. Various implementations of world models are known in the art.

The object classifier 4004 classifies the objects into classifications. The classifications may be general or specific, depending on the implementation of the object classifier 4004 and the need or desire for classification specificity in downstream components. Some examples of object classifications include vehicles, pedestrians, cyclists and motorcyclists, traffic infrastructure, road obstacles, animals, road features, intersections and junctions, and environmental elements. As an example, a greater classification specificity for the general classification of “vehicles” could be cars, buses, trucks, and so on. The object classifier 4004 may utilize an object's location, pose, motion, or other information to aid in its classification. The object classifier 4004 outputs information indicating the objects and their classifications (and optionally their locations, poses, motions, etc.), i.e., the classified objects 4100, to a trajectory planner 4006 (described below) and a hazard identifier 4008 (described further below). Various implementations of object classifiers are known in the art.

The trajectory planner 4006 determines an intended trajectory, or planned path 4108, to advance the vehicle to a destination while safely navigating the classified objects. As indicated above, navigation may involve the vehicle slowing down for some classified objects and driving around for other classified objects. The trajectory planner 4006 may consider myriad objectives then determining the planned path 4108, such as occupant safety, bystander safety, occupant comfort, efficiency, weather conditions, and so on. The trajectory planner 4006 outputs the planned path 4108 to the path optimizer 4012. Various implementations of trajectory planners are known in the art.

The driver-in-the-loop risk mitigator 4020 comprises several components, including the hazard identifier 4008, a lateral-constraint identifier 4010, a path optimizer 4012, a manual-driving detector 4014, a lateral-violation detector 4016, and a speed modifier 4018. Some implementations of the driver-in-the-loop risk mitigator 4020 include more or fewer components than those shown in FIG. 4.

The hazard identifier 4008 receives the classified objects 4100 from the object classifier 4004 and determines a hazard 4102 for each classified object 4100. In some implementations, the hazard identifier 4008 may comprise a database, lookup table, or other form of computer-readable memory that stores hazards 4102 and that can be indexed by the classified objects 4100 (e.g., by object classifications). Other implementations for the hazard identifier 4008 are within the scope of this disclosure, such as programmatic or rule-based systems for determining the hazards 4102, machine-learning (ML) or artificial-intelligence (AI) models for determining the hazards 4102, and so on.

The hazards 4102 may have different risk levels associated therewith, such that hazards 4102 can be compared and/or ranked. The risk levels may account for probability of the hazard 4102 occurring, severity of the occurrence of the hazard 4102, and so on. Various implementations for assigning risk levels to hazards are known in the art.

As an example of determining hazards 4102 for classified objects 4100, the hazard identifier 4008 may receive classified objects 4100 comprising a “delivery truck” and a “school bus.” While these are both vehicles, they may exhibit different hazards to the vehicle. The delivery truck may exhibit a hazard of the driver-side door opening unexpectedly, while the school bus may exhibit a hazard of children unexpectedly approaching or leaving the school bus. Thus, the hazard identifier 4008 may determine a “driver-side door opening” hazard 4102 for the delivery truck and a “children present” hazard 4102 for the school bus.

In some implementations, the hazard identifier 4008 may identify several hazards for a single classified object 4100. In some implementations, the hazard identifier 4008 may identify the highest-risk hazard and use that as the determined hazard 4102 for the classified object 4100, disregarding the lower-risk hazard. For example, an object classified as a “cyclist” may exhibit a first hazard of “unexpected left turn” and a second hazard of “sudden stop.” If the hazard identifier 4008 determines that “unexpected left turn” is higher risk than “sudden stop,” then the determined hazard 4102 for the cyclist is “unexpected left turn.” In other implementations, the hazard identifier 4008 may use the lower-risk hazard as the determined hazard 4102, and in still other implementations, the hazard identifier 4008 may combine the hazards into a hybrid hazard and use that as the determined hazard 4102. The hazard identifier 4008 outputs the hazards 4102 to the lateral-constraint identifier 4010. Although not specifically illustrated in FIG. 4, the hazard identifier 4008 may pass along the classified objects 4100 (and their locations, poses, motions, etc.) for use by downstream components as well, such as the path optimizer 4012.

The lateral-constraint identifier 4010 receives the hazards 4102 from the hazard identifier 4008 and determines a lateral constraint 4104 for each hazard 4102. In some implementations, the lateral-constraint identifier 4010 associated each classified object 4100 with a lateral constraint 4104 based on the hazard 4102 of the classified object 4100. In some implementations, the lateral-constraint identifier 4010 may comprise a database, lookup table, or other form of computer-readable memory that stores lateral constraints 4104 and that can be indexed by the hazards 4102 (or by more generalized hazard types of the hazards 4102). Other implementations for the lateral-constraint identifier 4010 are within the scope of this disclosure, such as programmatic or rule-based systems for determining the lateral constraints 4104, ML or AI models for determining the lateral constraints 4104, and so on.

Each lateral constraint 4104 is a minimum allowed distance between the vehicle and the associated classified object (based on the hazard 4102 determined for the classified object 4100, as described above). In some implementations, the lateral constraints 4104 are also a function of a speed of the vehicle, such as the vehicle's current speed. For example, if the vehicle is currently moving slowly (in the primary direction of travel), then the lateral constraints 4104 may be smaller than if the vehicle is currently moving quickly (in the primary direction of travel). In some implementations, the lateral constraints 4104 are also a function of a speed of the vehicle, a speed of the object, or both (e.g., a relative speed). In some implementations, the lateral constraints 4104 are also a function of environmental conditions in a vicinity of the vehicle, such as weather, season, time of day, and so on.

For simplicity, this disclosure illustrates and details implementations of the lateral-constraint identifier 4010 where a given classified object 4100 is associated with a single lateral constraint 4104 that applies along an entire length of the classified object (e.g., in the primary direction of travel of the vehicle). However, in some implementations, a given classified object 4100 may be associated with multiple lateral constraints 4104 that differ along the length of the object (e.g., in the primary direction of travel of the vehicle). The lateral-constraint identifier 4010 outputs the lateral constraints 4104 to the path optimizer 4012. Although not specifically illustrated in FIG. 4, the lateral-constraint identifier 4010 may pass along the classified objects 4100 (and their locations, poses, motions, etc.) for use by downstream components as well, such as the path optimizer 4012.

The path optimizer 4012 receives the lateral constraints 4104 from the lateral-constraint identifier 4010 the planned path 4108 from the trajectory planner 4006, and determines an optimized path 4110 therefrom. The optimized path 4110 is based on the planned path 4108 and takes into account the additional lateral constraints 4104. In some cases, for example when the lateral constraints 4104 are small and/or distant from the planned path 4108, the optimized path 4110 may be identical or nearly identical to the planned path 4108. In some cases, for example when the lateral constraints 4104 are large and/or close or overlapping to the planned path 4108, the optimized path 4110 may deviate substantially from the planned path 4108. In some implementations, the path optimizer 4012 receives information indicating predicted motions of the classified objects 4100 (e.g., from the world model 4002 or via downstream components thereof) and determines the optimized path 4110 further based on the predicted motions of the classified objects 4100.

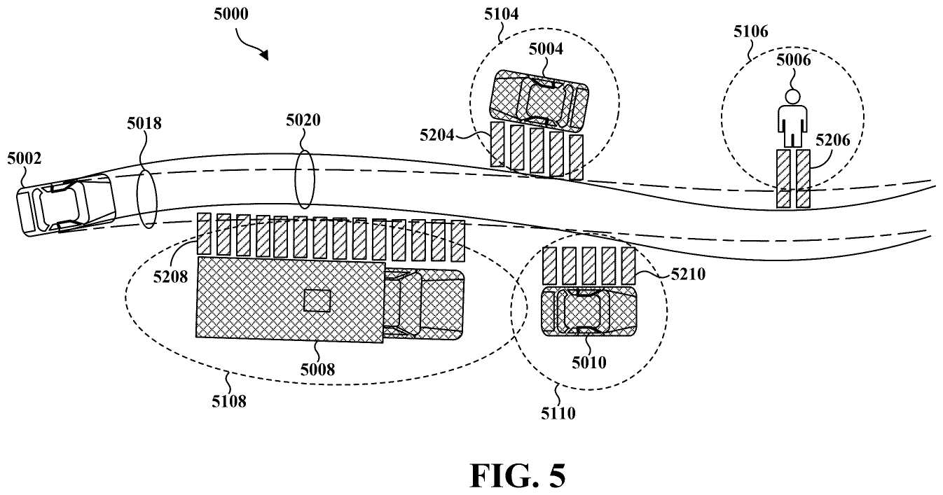

FIG. 5 is a diagram of an example of an environment 5000 for which a planned path 5018 and an optimized path 5020 have been determined for a vehicle 5002 in the environment 5000. The environment 5000 comprises objects 5004, 5006, 5008, and 5010. A trajectory planner, such as the trajectory planner 4006 shown in FIG. 4, determines the planned path 5018, which may be the planned path 4108 shown in FIG. 4. As an example, the trajectory planner may consider the dashed shapes around each object as boundaries, specifically, boundaries 5104, 5106, 5108, and 5110, when determining the planned path 5018.

Adjacent to the objects 5004, 5006, 5008, and 5010 are lateral constraints 5204, 5206, 5208, and 5210, respectively (for simplicity, only lateral constraints facing the planned path 5018 are shown in FIG. 5.) A path optimizer, such as the path optimizer 4012, optimizes the planned path 5018 to determine an optimized path 5020 based on the lateral constraints 5204, 5206, 5208, and 5210. Methods for determining an optimized path are described in U.S. patent application Ser. No. 16/528,204, which is incorporated herein by reference. In some implementations, the path optimizer 4012 determines the optimized path 4110 by considering all lateral constraints 4104 simultaneously. The path optimizer 4012 outputs the optimized path 4110 to the manual-driving detector 4014.

The manual-driving detector 4014 determines whether the vehicle is steering under autonomous steering control or the driver has taken control of steering of the vehicle, e.g., executed a steering override. In some implementations, the manual-driving detector 4014 determines that the vehicle is under manual steering control based on the magnitude of the lateral deviations, |e_{y}|, of the vehicle from the optimized path 4110. Specifically, the manual-driving detector 4014 determines whether the vehicle deviates more than a predefined threshold deviation, δₑ, to the left or right of the optimized path 4110. Various sensors, such as the sensors 1360 shown in FIG. 1, may be used to determine the vehicle's lateral position relative to the optimized path.

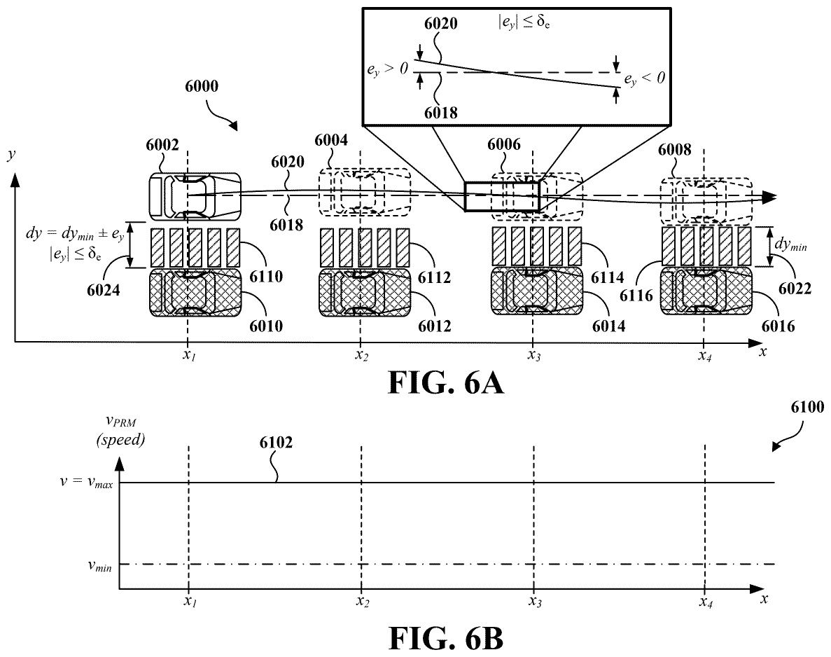

FIG. 6A is diagram of an example of a system for driver-in-the-loop lateral proximity risk mitigation under a scenario 6000 where lateral deviations, e_{y}, from an optimized path 6018 are less than or equal to the predefined threshold deviation, δₑ (i.e., |e_{y}|≤δₑ). The optimized path 6018 is shown as a dashed line and the actual path 6020 is shown as a solid line. The optimized path 6018 may be the optimized path 4110 shown in FIG. 4 and the vehicle 6002 may be the vehicle 1050 shown in FIG. 1. The vehicle 6002 is shown in additional positions 6004, 6006, and 6008. Four objects 6010, 6012, 6014, and 6016 are shown with respective lateral constraints 6110, 6112, 6114, and 6116. For simplicity, the optimized path 6018 (as well as the actual path 6020) is illustrated with a single line indicating a centerline of the vehicle 6002, whereas in FIG. 5 the optimized path 5020 (as well as the planned path 6018) is shown as a pair of lines indicating a width of the vehicle 5002.

Subthreshold lateral deviations 4114, which are less than or equal to the predefined threshold deviation, may be expected due to unmodeled vehicle dynamics. In this case, the manual-driving detector 4014 circumvents the remaining components of the driver-in-the-loop risk mitigator 4020. The manual-driving detector 4014 may output the subthreshold lateral deviations 4114, (|e_{y}|≤δₑ), for use in other components of the PRM system. Suprathreshold lateral deviations 4112, which are greater than the predefined threshold deviation, indicate that the driver has manually steered the vehicle away from the optimized path 4110. In this case, the manual-driving detector 4014 outputs the suprathreshold lateral deviations 4112 (|e_{y}|>δₑ), to the lateral-violation detector 4016.

In some implementations, the manual-driving detector 4014 determines that the vehicle is under manual steering control based on system status data indicating that the vehicle is in a manual steering mode.

In some implementations, the manual-driving detector 4014 determines that the vehicle is under manual steering control based on sensor data indicating a steering angle of a steering wheel of the vehicle differs by at least a predefined threshold angle from an expected steering angle based in the modified path. The steering wheel may be a component of the steering unit 1230 shown in FIG. 1 and the sensors that acquire the sensor data may be the sensors 1360 shown in FIG. 1.

The lateral-violation detector 4016 determines whether any of the lateral deviations 4112 violate or are predicted to violate any of the lateral constraints 4104. A lateral-constraint violation 4116, which may be referred to herein as simply a lateral violation 4116 or a violation 4116, occurs when the vehicle (e.g., a lateral edge thereof) overlaps or is predicted to overlap with a lateral constraint 4104 adjacent to a classified object 4100. In some implementations, the lateral-violation detector 4016 determines that the vehicle violates (or is predicted to violate) a lateral constraint 4104 based on a lateral distance, dy, between the vehicle (e.g., a lateral edge thereof) and the classified object 4100 (e.g., a lateral edge thereof) associated with the lateral constraint 4104. For simplicity, terms like “lateral-constraint violation,” “lateral violation,” and “violation” include both current (e.g., actual or physical) and predicted (e.g., future or expected) violations unless specified otherwise or clear from context.

In some implementations, the lateral distance, dy, is a physical lateral distance determined from sensor data from sensors of the vehicle, such as the sensors 1360 shown in FIG. 1. However, determining a physical lateral distance between the vehicle and a classified object 4100 requires that the vehicle be adjacent to the classified object 4100, which may not allow the downstream speed modifier 4018 sufficient time to react and safely slow the vehicle down when the physical lateral distance violates the associated lateral constraint 4104.

In some implementations, the lateral distance, dy, is a predicted, or virtual, lateral distance determined from sensor data from sensors of the vehicle, such as the sensors 1360 shown in FIG. 1. For example, a position of a classified object 4100 that is ahead of the vehicle (or a predicted position if the classified object 4100 is moving) can be determined based on sensor data from the sensors of the vehicle, and a predicted, or virtual, position of the vehicle can be determined based on a kinematic analysis of the vehicle according to, for example, a current pose of the vehicle, a current heading of the vehicle and/or a current steering angle of the vehicle, a current speed and/or acceleration of the vehicle, sensor data from sensors of the vehicle, and so on. Based on the position of the object and the predicted position of the vehicle, the predicted lateral distance between the prediction position of the vehicle and the classified object 4100 can be determined. If the predicted lateral distance is determined for a time or distance that is sufficiently ahead of the current time or distance, the downstream speed modifier 4018 may have sufficient time to react and safely slow the vehicle down when the predicted lateral distance violates the associated lateral constraint 4104. However, if the predicted lateral constraint is too far ahead in time or distance, then accuracy of the predicted lateral constraint may suffer.

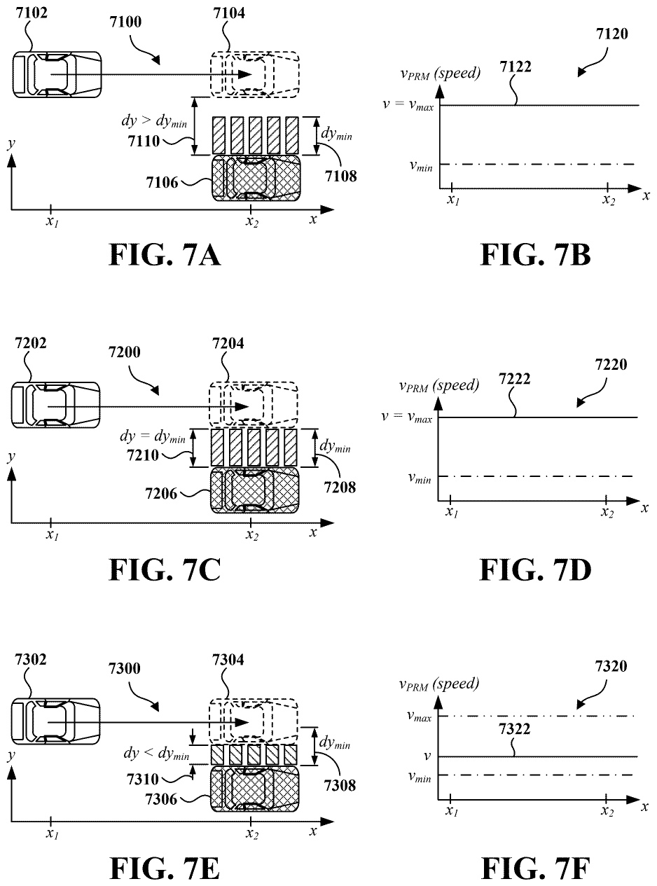

FIG. 7A shows an example of a scenario 7100 where a vehicle 7102 travels longitudinally to a position 7104, adjacent to an object 7106 having a lateral constraint 7108 of dyₘᵢₙ. The vehicle may be the vehicle 1050 shown in FIG. 1 and the object may be the classified object 4100 shown in FIG. 4. A lateral-violation detector, such as the lateral-violation detector 4016 shown in FIG. 4, determines a lateral distance 7110 of dy between the vehicle 7102 at the position 7104 and the object 7106. Because the lateral distance 7110 is greater than the lateral constraint 7108 (e.g., dy>dyₘᵢₙ), the lateral-violation detector does not determine a lateral-constraint violation.

FIG. 7C shows an example of a scenario 7200 where a vehicle 7202 travels longitudinally to a position 7204, adjacent to an object 7206 having a lateral constraint 7208 of dyₘᵢₙ. The vehicle may be the vehicle 1050 shown in FIG. 1 and the object may be the classified object 4100 shown in FIG. 4. A lateral-violation detector, such as the lateral-violation detector 4016 shown in FIG. 4, determines a lateral distance 7210 of dy between the vehicle 7202 at the position 7204 and the object 7206. Because the lateral distance 7110 is equal to the lateral constraint 7208 (e.g., dy=dyₘᵢₙ), the lateral-violation detector does not determine a lateral-constraint violation.

FIG. 7E shows an example of a scenario 7300 where a vehicle 7302 travels longitudinally to a position 7304, adjacent to an object 7306 having a lateral constraint 7308 of dyₘᵢₙ. The vehicle may be the vehicle 1050 shown in FIG. 1 and the object may be the classified object 4100 shown in FIG. 4. A lateral-violation detector, such as the lateral-violation detector 4016 shown in FIG. 4, determines a lateral distance 7310 of dy between the vehicle 7302 at the position 7304 and the object 7306. Because the lateral distance 7110 is less than the lateral constraint 7208 (e.g., dy<dyₘᵢₙ), the lateral-violation detector does determines a lateral-constraint violation.

Returning to FIG. 4, the speed modifier 4018 modifies at least one speed of the speed profile 4106. The speed profile 4106 comprises at least one speed for the vehicle to obey as it follows a determined path, such as the planned path 4108. The speed profile 4106 may be a continuous-time function or a discrete-time function.

FIG. 6B shows an example of a speed vs. position graph 6100 (v_{PRM}, vs. x, where PRM stands for proactive risk mitigation) of a speed profile 6102 that comprises a same speed (v) applied at all longitudinal (xᵢ) positions along the optimized path 6018 shown in FIG. 6A. The speed profile may be the speed profile 4106 shown in FIG. 4 (or a modified speed profile 4118, as explained below). In the example scenario 6000 shown in FIG. 6A, all lateral constraints 6110, 6112, 6114, and 6116 are equal to a distance 6022, dyₘᵢₙ, and at all positions of the vehicle 6002, the vehicle 6002 is located a lateral distance 6024 from the respective objects 6010, 6012, 6014, and 6016 of dy=dyₘᵢₙ±e_{y}, where |e_{y}|≤δₑ. Because there are no lateral-constraint violations, a lateral-violation detector, such as the lateral-violation detector 4016 shown in FIG. 4, would not modify any speed of the speed profile 6102. Accordingly, in this example, the speed profile 6102 is both a speed profile associated with a planned path and a modified speed profile where no speed was modified. FIGS. 7B and 7D show similar scenarios to that shown in FIG. 6B, described below.

FIG. 7B shows an example of a speed vs. position graph 7120 (v_{PRM}, vs. x) of a speed profile 7122 corresponding to the scenario 7100 shown in FIG. 7A. As explained earlier, the vehicle 7102 at the position 7104 does not violate the lateral constraint 7108 (dy>dyₘᵢₙ). Accordingly, no speed of a speed profile associated with a planned path is modified by a speed modifier, such as the speed modifier 4018 shown in FIG. 4. The speed profile 7122 is therefore both the speed profile associated with the planned path and a modified speed profile where no speed was modified.

FIG. 7D shows an example of a speed vs. position graph 7220 (v_{PRM}, vs. x) of a speed profile 7222 corresponding to the scenario 7200 shown in FIG. 7C. As explained earlier, the vehicle 7202 at the position 7204 does not violate the lateral constraint 7208 (dy=dyₘᵢₙ). Accordingly, no speed of a speed profile associated with a planned path is modified by a speed modifier, such as the speed modifier 4018 shown in FIG. 4. The speed profile 7222 is therefore both the speed profile associated with the planned path and a modified speed profile where no speed was modified.

FIG. 7F shows an example of a speed vs. position graph 7320 (v_{PRM}, vs. x) of a speed profile 7322 corresponding to the scenario 7300 shown in FIG. 7E. As explained earlier, the vehicle 7302 at the position 7304 violates the lateral constraint 7308 (dy<dyₘᵢₙ). Accordingly, at least one speed of a speed profile associated with a planned path is modified by a speed modifier, such as the speed modifier 4018 shown in FIG. 4. The speed profile 7322 is therefore a modified speed profile.

The implementations illustrated in FIGS. 7B, 7D, and 7E correspond to a speed modifier, such as the speed modifier 4018 shown in FIG. 4, that determines a flat (e.g., constant) modified speed profile, such as the modified speed profile 4118 shown in FIG. 4. Here, the speed modifier reduces all speeds of the speed profile to satisfy the worst-case lateral-constraint violation. However, this can result in overly cautious and/or slow longitudinal movement of the vehicle.

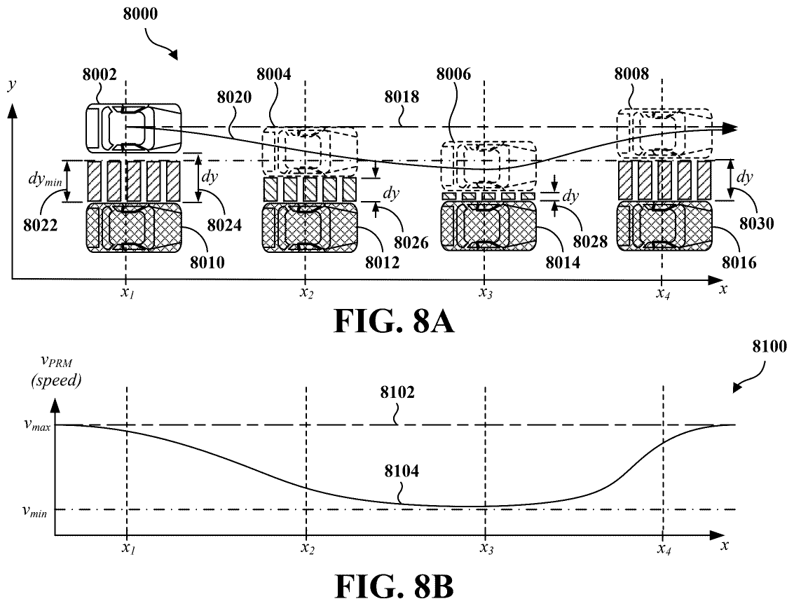

The implementation illustrated in FIGS. 8A-8B correspond to a speed modifier, such as the speed modifier 4018 shown in FIG. 4, that determines a modified speed profile that comprises a reduction in a speed (or reductions in speeds) associated with only a portion of the optimized path (or actual path) within a proximity of the object whose lateral constraint is violated. In other words, a vehicle obeying the modified speed profile will slow down when it is near the objects for which it violates the lateral constraints and it will maintain or resume an original speed of the speed profile when it is safely away from those objects.

FIG. 8A shows an example of a scenario 8000 where a vehicle 8002 travels longitudinally along an actual path 8020 that deviates from an optimized path 8018 adjacent to objects 8010, 8012, 8014, and 8016 each associated with a lateral constraint 8022 equal to dyₘᵢₙ. The vehicle may be the vehicle 1050 shown in FIG. 1 and the optimized path may be the optimized path 4110 shown in FIG. 4. A lateral-violation detector, such as the lateral-violation detector 4016 shown in FIG. 4, determines whether the vehicle 8002 violates any of the lateral constraints 8022 by determining lateral distances, dy, between the vehicle 8002 at the various positions and the objects 8010, 8012, 8014, and 8016.

In the scenario 8000, the lateral distance 8024 between the vehicle 8002 and the object 8010 is greater than the lateral constraint 8022; therefore, a speed modifier, such as the speed modifier 4018 shown in FIG. 4, receives no indication of a lateral violation at that position from a lateral-violation detector, such as the lateral-violation detector 4016 shown in FIG. 4. The lateral distance 8026 between the vehicle 8002 at the position 8004 and the object 8012 is less than the lateral constraint 8022; therefore, the speed modifier receives an indication of a lateral violation at that position from the lateral-violation detector. The lateral distance 8028 between the vehicle 8002 at the position 8006 and the object 8014 is less than the lateral constraint 8022; therefore, the speed modifier receives an indication of the lateral violation at that position from a lateral-violation detector. Finally, the lateral distance 8030 between the vehicle 8002 at the position 8008 and the object 8016 is greater than the lateral constraint 8022; therefore, the speed modifier receives no indication of a lateral violation at that position from the lateral-violation detector.

FIG. 8B shows an example of a speed vs. position graph 8100 (v_{PRM}, vs. x) of a speed profile 8102 corresponding to the optimized path 8018 shown in FIG. 8A and a modified speed profile 8104 based on the scenario 8000 shown in FIG. 8A, where only a portion of the speed profile is modified. The modified speed profile 8102 may be the modified speed profile 4118 shown in FIG. 4. Specifically, the modified speed profile 8104 comprises significantly reduced speeds (with respect to the speed profile 8102) at the positions x₂ and x₃, where the lateral constraint 8022 is violated in the scenario 8000 shown in FIG. 8A, and comprises non-reduced or nominally reduced speeds at the positions x₁ and x₄, where the lateral constraint 8022 is not violated in the scenario 8000 shown in FIG. 8A.

A nominal reduction in speed may be a result of the techniques used by the lateral-violation detector 4016 in connection with the speed modifier 4018. For example, if the lateral distances are predicted lateral distances as described above, then the speed modifier 4018 nominally reduces certain speeds of the speed profile 4106 to provide for smooth and comfortable accelerations and/or decelerations of the vehicle along the modified speed path. Specifically, in some implementations, the speed modifier 4018 determines the modified speed profile 4118 that comprises: a gradual reduction in multiple speeds of the speed profile 4106 associated with a first portion of the optimized path 4110 before a classified object 4100, and a reduction in the speed associated with a second portion of the optimized path 4110 that is contiguous with the first portion of the optimized path 4110 and within a proximity of the classified object 4100. In some implementations, the reduction in the speed is proportional to a spatial extent of the current or future lateral violation 4116. In some implementations, some reductions in speed are a result of interpolations between other reductions in speed.

As illustrated in FIG. 8A, the actual path 8020 veers toward the objects 8012 and 8014, and then veers away from the object 8016, depicting manual steering by a driver of the vehicle 8002. Because a trajectory of the vehicle 8002 between the position x₃ and x₄ indicates that a predicted position of the vehicle 8002 will result in a predicted lateral distance 8030 that is greater than the lateral constraint 8022, the speed modifier, such as the speed modifier 4018 shown in FIG. 4, can begin increasing one or more speeds of the modified speed profile 8104 to return to those of the speed profile 8102. Specifically, in some implementations, the speed modifier 4018: determines a lateral movement of the vehicle away from a classified object 4100 that causes a reduced spatial extent of the current or future lateral violation 4116; and redetermines the modified speed profile 4118 wherein the reduction in the speed is proportional to the reduced spatial extent of the current or future lateral violation 4116. Similarly, in some implementations, the speed modifier 4018: determines a lateral movement of a classified object 4100 away from the vehicle that causes a reduced spatial extent of the current or future lateral violation 4116; and redetermines the modified speed profile 4118 wherein the reduction in the speed is proportional to the reduced spatial extent of the current or future lateral violation 4116.

The modified speed profile 4118 is output by the driver-in-the-loop risk mitigator 4020 to downstream components of a PRM system. Accordingly, the driver-in-the-loop risk mitigator 4020 causes the vehicle to obey the modified speed profile 4118. The optimized path 4110 is also output by the driver-in-the-loop risk mitigator 4020 to downstream components of a PRM system, so that in cases where the lateral deviations 4112 are subthreshold, e.g., manual driving is not detected, the vehicle can follow the optimized path 4110 instead of the planned path 4108. In some implementations, the driver-in-the-loop risk mitigator 4020 generates (or causes another component of the PRM system to generate) an alert to an operator of the vehicle in response to determining that the vehicle has deviated sufficiently from the optimized path 4110 to cause the current or future lateral violation 4116.

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 9000 described below is a technique for driver-in-the-loop lateral proximity risk mitigation. This technique may be implemented by a system whose components may be internal and/or external to a vehicle, such as the controller 1300 shown FIG. 1 or the computing apparatus 2410 of the data center 2400 shown in FIG. 2.

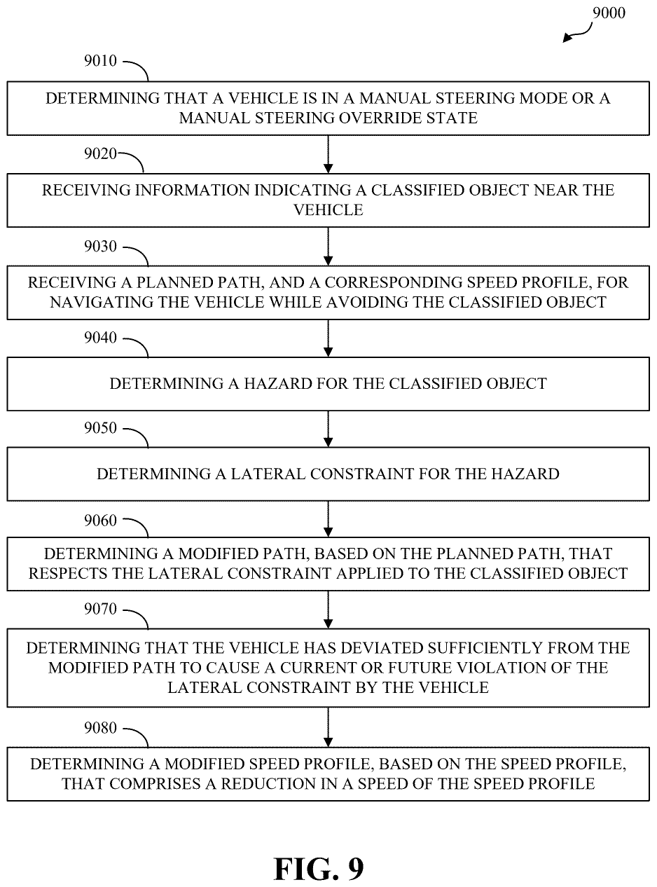

FIG. 9 is a flowchart of an example of a process for driver-in-the-loop lateral proximity risk mitigation. The step 9010 comprises determining that a vehicle is in a manual steering mode or a manual steering override state. The vehicle may be the vehicle 1050 shown in FIG. 1. The planned path may be the planned path 4108 shown in FIG. 4. In some implementations, the process includes determining that the vehicle is in the manual steering mode based on system status data. In some implementations, the process includes determining that the vehicle is in the manual steering override state based on sensor data indicating a steering angle of a steering wheel of the vehicle differs by at least a predefined threshold angle from an expected steering angle based on a modified path (the modified path is described in step 9060). In some implementations, the process includes determining that the vehicle is in the manual steering override state by determining that a lateral deviation of the vehicle from a modified path exceeds a predefined threshold deviation (the modified path is described in step 9060).

The step 9020 comprises receiving information indicating a classified object near the vehicle. The classified object may be the classified object 4100 shown in FIG. 4. In some implementations, the process includes receiving the information indicating the classified object from a world model of a proactive risk mitigation system of the vehicle, such as the world model 4002 shown in FIG. 4.

The step 9030 comprises receiving a planned path, and a corresponding speed profile, for navigating the vehicle while avoiding the classified object. The planned path may be the planned path 4108 shown in FIG. 4 and the speed profile may be the speed profile 4106 shown in FIG. 4.

The step 9040 comprises determining a hazard for the classified object. The hazard may be the hazards 4102 shown in FIG. 4.

The step 9050 comprises determining a lateral constraint for the hazard. The lateral constraint may be the lateral constraints 4104 shown in FIG. 4. In some implementations, the lateral constraint is a minimum allowed distance between the vehicle and the classified object as a function of a speed of the vehicle. In some implementations, the lateral constraint is a minimum allowed distance between the vehicle and the classified object as a function of weather conditions in a vicinity of the vehicle.

The step 9060 comprises determining a modified path, based on the planned path, that respects the lateral constraint applied to the classified object. The modified path may be the optimized path 4110 shown in FIG. 4. In some implementations, the process includes: receiving information indicating a predicted motion of the classified object; and determining the modified path further based on the predicted motion of the classified object.

The step 9070 comprises determining that the vehicle has deviated sufficiently from the modified path to cause a current or future violation of the lateral constraint by the vehicle. The current of future violation may be the violations 4116 shown in FIG. 4. In some implementations, the process includes determining that the vehicle has deviated sufficiently from the modified path to cause the current or future violation by detecting, using a sensor of the vehicle, a lateral distance between the vehicle and the classified object and comparing the lateral distance to the lateral constraint. In some implementations, the process includes determining that the vehicle has deviated sufficiently from the modified path to cause the current or future violation by: determining a predicted position of the vehicle at least up to the classified object, determining a predicted lateral distance between the classified object and the predicted position of the vehicle, and comparing the predicted lateral distance to the lateral constraint.

The step 9080 comprises determining a modified speed profile, based on the speed profile, that comprises a reduction in a speed of the speed profile. The modified speed profile may be the modified speed profile 4118 shown in FIG. 4. In some implementations, the process includes determining the modified speed profile that comprises the reduction in the speed associated with only a portion of the modified path within a proximity of the classified object. In some implementations, the process includes determining the modified speed profile that comprises: a gradual reduction in multiple speeds of the speed profile associated with a first portion of the modified path before the classified object, and the reduction in the speed associated with a second portion of the modified path that is contiguous with the first portion and within a proximity of the classified object. In some implementations, the reduction in the speed is proportional to a spatial extent of the current or future violation.

In some implementations, the process includes: determining a lateral movement of the vehicle away from the classified object that causes a reduced spatial extent of the current or future violation; and redetermining the modified speed profile wherein the reduction in the speed is proportional to the reduced spatial extent of the current or future violation.

In some implementations, the process includes: determining a lateral movement of the classified object away from the vehicle that causes a reduced spatial extent of the current or future violation; and redetermining the modified speed profile wherein the reduction in the speed is proportional to the reduced spatial extent of the current or future violation.

In some implementations, the process includes generating an alert to an operator of the vehicle in response to determining that the vehicle has deviated sufficiently from the modified path to cause the current or future violation.

In some implementations, the process includes causing the vehicle to obey the modified speed profile.

In some implementations, the process includes: receiving information indicating a plurality of classified object near the vehicle; receiving the planned path, and the corresponding speed profile, for navigating the vehicle while avoiding the plurality of classified objects; determining a plurality of hazards for the plurality of classified objects; determining a plurality of lateral constraints for the plurality of hazards; determining the modified path that respects the plurality of lateral constraints applied to the plurality of classified objects; and determining that the vehicle has deviated sufficiently from the modified path to cause a violation of any one of the plurality of lateral constraints by the vehicle.

The above-described techniques can be implemented as a method, a system, and a non-transitory computer-readable medium, for example, as described below.

In an example implementation as a method, the method comprises: determining that a vehicle is in a manual steering mode or a manual steering override state; receiving information indicating a classified object near the vehicle; receiving a planned path, and a corresponding speed profile, for navigating the vehicle while avoiding the classified object; determining a hazard for the classified object; determining a lateral constraint for the hazard; determining a modified path, based on the planned path, that respects the lateral constraint applied to the classified object; determining that the vehicle has deviated sufficiently from the modified path to cause a current or future violation of the lateral constraint by the vehicle; and determining a modified speed profile, based on the speed profile, that comprises a reduction in a speed of the speed profile.

In some implementations, the method further comprises: determining that the vehicle is in the manual steering mode based on system status data.

In some implementations, the method further comprises: determining that the vehicle is in the manual steering override state based on sensor data indicating a steering angle of a steering wheel of the vehicle differs by at least a predefined threshold angle from an expected steering angle based on the modified path.

In some implementations, the method further comprises: determining that the vehicle is in the manual steering override state by determining that a lateral deviation of the vehicle from the modified path exceeds a predefined threshold deviation.

In some implementations, the method further comprises: receiving the information indicating the classified object from a world model of a proactive risk mitigation system of the vehicle.

In some implementations, the method further comprises: receiving information indicating a predicted motion of the classified object; and determining the modified path further based on the predicted motion of the classified object.

In some implementations, the method further comprises: determining the modified speed profile that comprises the reduction in the speed associated with only a portion of the modified path within a proximity of the classified object.

In some implementations, the method further comprises: determining the modified speed profile that comprises: a gradual reduction in multiple speeds of the speed profile associated with a first portion of the modified path before the classified object, and the reduction in the speed associated with a second portion of the modified path that is contiguous with the first portion and within a proximity of the classified object.

In some implementations, the reduction in the speed is proportional to a spatial extent of the current or future violation.

In some implementations, the method further comprises: determining a lateral movement of the vehicle away from the classified object that causes a reduced spatial extent of the current or future violation; and redetermining the modified speed profile wherein the reduction in the speed is proportional to the reduced spatial extent of the current or future violation.

In some implementations, the method further comprises: determining a lateral movement of the classified object away from the vehicle that causes a reduced spatial extent of the current or future violation; and redetermining the modified speed profile wherein the reduction in the speed is proportional to the reduced spatial extent of the current or future violation.

In some implementations, the lateral constraint is a minimum allowed distance between the vehicle and the classified object as a function of a speed of the vehicle.

In some implementations, the lateral constraint is a minimum allowed distance between the vehicle and the classified object as a function of weather conditions in a vicinity of the vehicle.

In some implementations, the method further comprises: generating an alert to an operator of the vehicle in response to determining that the vehicle has deviated sufficiently from the modified path to cause the current or future violation.

In some implementations, the method further comprises: causing the vehicle to obey the modified speed profile.

In some implementations, the method further comprises: determining that the vehicle has deviated sufficiently from the modified path to cause the current or future violation by detecting, using a sensor of the vehicle, a lateral distance between the vehicle and the classified object and comparing the lateral distance to the lateral constraint.

In some implementations, the method further comprises: determining that the vehicle has deviated sufficiently from the modified path to cause the current or future violation by: determining a predicted position of the vehicle at least up to the classified object, determining a predicted lateral distance between the classified object and the predicted position of the vehicle, and comparing the predicted lateral distance to the lateral constraint.

In some implementations, the method further comprises: receiving information indicating a plurality of classified object near the vehicle; receiving the planned path, and the corresponding speed profile, for navigating the vehicle while avoiding the plurality of classified objects; determining a plurality of hazards for the plurality of classified objects; determining a plurality of lateral constraints for the plurality of hazards; determining the modified path that respects the plurality of lateral constraints applied to the plurality of classified objects; and determining that the vehicle has deviated sufficiently from the modified path to cause a violation of any one of the plurality of lateral constraints by the vehicle.

In another example implementation as a non-transitory computer-readable medium, the non-transitory computer-readable medium stores instructions operable to cause one or more processors to perform operations comprising: determining that a vehicle is in a manual steering mode or a manual steering override state; receiving information indicating a classified object near the vehicle; receiving a planned path, and a corresponding speed profile, for navigating the vehicle while avoiding the classified object; determining a hazard for the classified object; determining a lateral constraint for the hazard; determining a modified path, based on the planned path, that respects the lateral constraint applied to the classified object; determining that the vehicle has deviated sufficiently from the modified path to cause a current or future violation of the lateral constraint by the vehicle; and determining a modified speed profile, based on the speed profile, that comprises a reduction in a speed of the speed profile.

In another example implementation as a system, the system comprises one or more memories; and one or more processors configured to execute instructions stored in the one or more memories to: determine that a vehicle is in a manual steering mode or a manual steering override state; receive information indicating a classified object near the vehicle; receive a planned path, and a corresponding speed profile, for navigating the vehicle while avoiding the classified object; determine a hazard for the classified object; determine a lateral constraint for the hazard; determine a modified path, based on the planned path, that respects the lateral constraint applied to the classified object; determine that the vehicle has deviated sufficiently from the modified path to cause a current or future violation of the lateral constraint by the vehicle; and determine a modified speed profile, based on the speed profile, that comprises a reduction in a speed of the speed profile.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
determining that a vehicle is in a manual steering mode or a manual steering override state;
receiving information indicating a classified object near the vehicle;
receiving a planned path, and a corresponding speed profile, for navigating the vehicle while avoiding the classified object;
determining a hazard for the classified object;
determining a lateral constraint for the hazard;
determining a modified path, based on the planned path, that respects the lateral constraint applied to the classified object;
determining that the vehicle has deviated sufficiently from the modified path to cause a current or future violation of the lateral constraint by the vehicle; and
determining a modified speed profile, based on the speed profile, that comprises a reduction in a speed of the speed profile.

2. The method of claim 1, further comprising:
determining that the vehicle is in the manual steering mode based on system status data.

3. The method of claim 1, further comprising:
determining that the vehicle is in the manual steering override state based on sensor data indicating a steering angle of a steering wheel of the vehicle differs by at least a predefined threshold angle from an expected steering angle based on the modified path.

4. The method of claim 1, further comprising:
determining that the vehicle is in the manual steering override state by determining that a lateral deviation of the vehicle from the modified path exceeds a predefined threshold deviation.

5. The method of claim 1, further comprising:
receiving the information indicating the classified object from a world model of a proactive risk mitigation system of the vehicle.

6. The method of claim 1, further comprising:
receiving information indicating a predicted motion of the classified object; and
determining the modified path further based on the predicted motion of the classified object.

7. The method of claim 1, further comprising:
determining the modified speed profile that comprises the reduction in the speed associated with only a portion of the modified path within a proximity of the classified object.

8. The method of claim 1, further comprising:
determining the modified speed profile that comprises:
a gradual reduction in multiple speeds of the speed profile associated with a first portion of the modified path before the classified object, and
the reduction in the speed associated with a second portion of the modified path that is contiguous with the first portion and within a proximity of the classified object.

9. The method of claim 1, wherein:
the reduction in the speed is proportional to a spatial extent of the current or future violation.

10. The method of claim 1, further comprising:
determining a lateral movement of the vehicle away from the classified object that causes a reduced spatial extent of the current or future violation; and
redetermining the modified speed profile wherein the reduction in the speed is proportional to the reduced spatial extent of the current or future violation.

11. The method of claim 1, further comprising:
determining a lateral movement of the classified object away from the vehicle that causes a reduced spatial extent of the current or future violation; and
redetermining the modified speed profile wherein the reduction in the speed is proportional to the reduced spatial extent of the current or future violation.

12. The method of claim 1, wherein:
the lateral constraint is a minimum allowed distance between the vehicle and the classified object as a function of a speed of the vehicle.

13. The method of claim 1, wherein:
the lateral constraint is a minimum allowed distance between the vehicle and the classified object as a function of weather conditions in a vicinity of the vehicle.

14. The method of claim 1, further comprising:
generating an alert to an operator of the vehicle in response to determining that the vehicle has deviated sufficiently from the modified path to cause the current or future violation.

15. The method of claim 1, further comprising:
causing the vehicle to obey the modified speed profile.

16. The method of claim 1, further comprising:
determining that the vehicle has deviated sufficiently from the modified path to cause the current or future violation by detecting, using a sensor of the vehicle, a lateral distance between the vehicle and the classified object and comparing the lateral distance to the lateral constraint.

17. The method of claim 1, further comprising:
determining that the vehicle has deviated sufficiently from the modified path to cause the current or future violation by:
determining a predicted position of the vehicle at least up to the classified object,
determining a predicted lateral distance between the classified object and the predicted position of the vehicle, and
comparing the predicted lateral distance to the lateral constraint.

18. The method of claim 1, further comprising:
receiving information indicating a plurality of classified object near the vehicle;
receiving the planned path, and the corresponding speed profile, for navigating the vehicle while avoiding the plurality of classified objects;
determining a plurality of hazards for the plurality of classified objects;
determining a plurality of lateral constraints for the plurality of hazards;
determining the modified path that respects the plurality of lateral constraints applied to the plurality of classified objects; and
determining that the vehicle has deviated sufficiently from the modified path to cause a violation of any one of the plurality of lateral constraints by the vehicle.

19. A non-transitory computer-readable medium storing instructions operable to cause one or more processors to perform operations comprising:
determining that a vehicle is in a manual steering mode or a manual steering override state;
receiving information indicating a classified object near the vehicle;
receiving a planned path, and a corresponding speed profile, for navigating the vehicle while avoiding the classified object;
determining a hazard for the classified object;
determining a lateral constraint for the hazard;
determining a modified path, based on the planned path, that respects the lateral constraint applied to the classified object;
determining that the vehicle has deviated sufficiently from the modified path to cause a current or future violation of the lateral constraint by the vehicle; and
determining a modified speed profile, based on the speed profile, that comprises a reduction in a speed of the speed profile.

20. A system, comprising:
one or more memories; and
one or more processors configured to execute instructions stored in the one or more memories to:
determine that a vehicle is in a manual steering mode or a manual steering override state;
receive information indicating a classified object near the vehicle;
receive a planned path, and a corresponding speed profile, for navigating the vehicle while avoiding the classified object;
determine a hazard for the classified object;
determine a lateral constraint for the hazard;
determine a modified path, based on the planned path, that respects the lateral constraint applied to the classified object;
determine that the vehicle has deviated sufficiently from the modified path to cause a current or future violation of the lateral constraint by the vehicle; and
determine a modified speed profile, based on the speed profile, that comprises a reduction in a speed of the speed profile.
